(19) United States
(12) Patent Application Publication
(10) Pub. No.: US 2009/0018875 A1
(43) Pub. Date: Jan. 15, 2009

(54) 1ST RESPONDER GUIDANCE AND DECISION-SUPPORT SYSTEM ENABLING VICTIM TRACKING AND EXTRACTION

(76) Inventors: SABATINI MONATESTI, BERWICK, PA (US); JACK MURPHY, LEONIA, NJ (US)

Correspondence Address: SABATINI MONATESTI, 919 BELAIR DRIVE, BERWICK, PA, 18603, US

(21) Appl. No.: 11/742,838

(22) Filed: May 1, 2007

(51) Int. Cl. G06Q 10/00

(52) U.S. Cl. 705/7

(57) ABSTRACT

The invention uses processes, algorithms and programs to support emergency personnel decisions. It consists of several automated and semi-automated software components, hardware components, and processes, which are integrated into a single system that streamlines building intelligence gathering and victim extraction processes, and provides emergency personnel decision support.

### BACKGROUND

1. Field of Invention

The present invention is a computer software method and apparatus designed to help 1^{st} Responders safely track and/or extract victims through use of building intelligence and least risk path algorithms. The invention consists of several automated and semi-automated software components, hardware components, and processes, which are integrated into a single system that streamlines building intelligence gathering and victim extraction processes, and provides 1^{st} Responder decision support.

2. Description of Prior Art

The invention is relevant to eight life and property safety areas: (a) building reconnaissance; (b) occupancy and intrusion detection; (c) fire & security systems with room control; (d) infrared detection systems; (e) building intelligence systems; (f) fire alarm and alerting systems; (g) location display and navigation apparatus; and (h) patient tracking, transport & information access in collaborative space.

The prior art contains different computerized systems for assisting 1^{st} Responder Units in the field. They include the following:

A. Building Reconnaissance
U.S. Pat. No. 6,980,920 (2005) to Teck Heng Lee discloses a method and apparatus describing a device for tracking moving objects or persons. The invention is an embedded system using a series of sensors such as light sensors along a passageway to determine some movement characteristics such as number, size, direction, speed and position of objects or people along the passageway. One embodiment of this invention is in fare gates for public transport systems. Another aspect of this invention is the algorithm that determines the movement characteristics using the overlaps or intersections of rising edge, on state, falling edge and off state of signals from the sensors to determine the movement characteristics of objects or humans. The simplicity and robustness of the algorithm allow implement of the invention with inexpensive programmable logical controllers without the need of control by expensive computers. This invention also avoids the attendant disadvantages of other systems using cameras, computer vision or mechanical sensors.
U.S. Pat. No. 6,583,723 (2003) to Masaki Watanabe, Kentaro Murase, Takuya Noda, Kazuhiro Watanabe discloses an image sensor, a voice sensor, an auxiliary sensor part (infrared sensor, etc.), a total analyzing part, and an application communicate with each other through data/control signal communication units. Each sensor provides feedback on its signal detection results and control information used by the other sensors for determining a range of a detection target and a detection sensitivity at a time of subsequent signal acquisition, to the other sensors through the communication units. The total analyzing part investigates whether or not there is inconsistency among the results detected by the respective sensors, and provides control information to each sensor. Each sensor determines a range of a signal detection target and a detection sensitivity based on the obtained information, and acquires a signal in accordance with the determination.

B. Occupancy & Intrusion Detection
U.S. Pat. No. 4,661,720 (1987) to Maclyn C. Cameron, Jr., Charles C. Hu, Jerome M. Mix discloses an improved apparatus for switching off power to an electric load in the absence of the detection of movement from the doppler shift of a transmission signal. An oscillator generates an ultrasonic transmission frequency which is transmitted via a transmission plate coupled to the oscillator. A plurality of receivers detect reflections of the ultrasonic sound signal and supply the detected signal to a bandpass filter which passes the transmission frequency. A low-pass demodulator will detect any doppler signal which modulates the transmission signal and will supply it to an amplifier for amplification. The amplified signal is then provided to a narrow band filter which will pass only a narrow band of doppler-shift signals which correspond to the frequencies of human movement. The signal is then supplied to a switching means which, when activated, will discharge a first node. The first node is charged via a resistor and a capacitor coupled to a voltage source.
U.S. Pat. No. 5,165,465 (1992) to Ran Kenet discloses how rooms in a building each have a heating, ventilating and air conditioning system (HVAC), a room control unit having a temperature controller, and various sensors is controlled. The control unit monitors the presence of persons in the room, determines the season, sets back the temperature in an empty room by a variable amount which the HVAC can restore in a given time, and restores the temperature to the previous user request when the user returns but to a standard temperature if the user has newly checked in. An outside hallway panel briefly displays, when interrogated by a maid, a person's presence. By monitoring maid requests, door status and maid activity, the unit indicates on a room map whether the room is being cleaned, clean, or ready to rent. By establishing the heat loss/gain (lg) factor of a room with the HVAC off and comparing it with the time to heat or cool the room, HVAC failures are determined. By comparing a room's lg factor with those of its neighbors, room environment failures
U.S. Pat. No. 3,846,790 (1974) to David P. Erdmann, Dennis L. Kurshner discloses a system for sensing seismic and magnetic disturbances, comprising a segmented transducer, such as a line sensor, and electronic circuitry for processing the signals developed by the segmented transducer. The segmented transducer comprises sets of windings wrapped around a ferromagnetic core. Currents are induced in transducer windings as a result of magnetostriction when seismic disturbances or stresses cause strains in the ferromagnetic core. Currents are also induced in the transducer windings by magnetic field disturbances caused by external ferrous objects; i.e., Electronic signal processing circuitry associated with the transducer extracts information from the induced seismic and magnetic signals and activates an alarm if the information meets predetermined criteria. Important criteria used include whether the seismic signals are impulses, whether the magnetic or stress disturbances are localized, and whiter specific thresholds of magnetic and stress activity are reached.
Vibration Monitor to Ascertain Victim Location: Vibration Monitor—Thomas Instruments—Vibration Monitoring Systems, WIN200S software is an easy-to-use and powerful program for analyzing and printing data collected with the VMS-200S. It integrates functions into one easy-to-use Windows environment. WIN200's integrated functions include: Configuration and control, Serial communications, High resolution printing on hundreds of printers, Seismographs log keeping, Binary to ASCII data conversion, and In-depth data analysis.
Intrusion Detection Support Victim Tracking: Security and surveillance systems that employ geophones to detect movement along borders, perimeters and in buildings, http://www.geospacelp.com/industry2.shtml
Seismic Buried Line Sensors: NASA Security Handbook (PART 4 of 5), http://www.fas.org/irp/doddir/other/nasa_hb_{—}1620_{—}3c.htm, Seismic Buried Line Sensors. A passive system that includes piezoelectric, pressure geophone sensors or their equivalent. This system should be capable of detecting an individual weighing more than 31.752 kg 70 pounds crossing the sensitive area of the system at a minimum speed of 0.15 meters per second, whether walking, crawling, or rolling. The system design should employ techniques to eliminate nuisance alarms from adverse environmental phenomena. The sensors should be installed at the depth below the ground surface stated by the manufacturer. Detection zones shall extend approximately 1 meter on each side of the buried transducers.

C. Fire & Security System with Room Control
U.S. Pat. No. 4,688,183 (1987) to Richard T. Carll, Barry G. Blackaby discloses a fire and security system that includes a hierarchical architecture with a central control processor monitoring each of a plurality of multi detector-occupancy-temperature-smoke (MDOTS) sensors mounted in each of the monitored spaces of the building, the MDOTS sensors connected in multi drop fashion in sensor loop networks which are connected to one of a plurality of master controls, each master control monitoring the sensor outputs from one or more sensor loops and reporting the alarm status of any one sensor to the central control system.
U.S. Pat. No. 5,079,422 (1992) to Jacob Y. Wong discloses a system for detecting fires uses at least two carbon dioxide sensors positioned at spaced locations in a room. Each sensor produces an electrical output signal representative of the carbon dioxide concentration in its vicinity. A computer calculates the ratio of the concentration sensed by each sensor to the concentration sensed by each of the other sensors, and any imbalance in the distribution of carbon dioxide will be reflected in these ratios. Random variations prevent the ratios from being equal, and the magnitude of the random variations is quantized by calculating the standard deviation of the ratios. The ratios are then normalized and compared to a threshold level that corresponds to a chosen false alarm rate.

D. Carbon Dioxide and Infrared Detection System
U.S. Pat. No. 5,079,422 (1992) to Jacob Y. Wong discloses a system for detecting fires uses at least two carbon dioxide sensors positioned at spaced locations in a room. Each sensor produces an electrical output signal representative of the carbon dioxide concentration in its vicinity. A computer calculates the ratio of the concentration sensed by each sensor to the concentration sensed by each of the other sensors, and any imbalance in the distribution of carbon dioxide will be reflected in these ratios. Random variations prevent the ratios from being equal, and the magnitude of the random variations is quantized by calculating the standard deviation of the ratios. The ratios are then normalized and compared to a threshold level that corresponds to a chosen false alarm rate.
U.S. Pat. No. 5,612,676 (1997) to Jonathan C. Plimpton, George L. Minott discloses a fire detection system including two optical sensing channels and signal processing circuitry that processes the two sensing channels' output signals and generates another output signal when the processed signals are indicative of a fire. The system automatically detects hydrocarbon and certain non-hydrocarbon fueled fires. The first sensing channel simultaneously senses IR radiation in two IR spectral regions having separate and distinct bandwidths and generates a first signal corresponding to incident IR radiation being sensed in at least one of these spectral regions. One bandwidth is selected so the first sensing channel is responsive to the IR radiation emitted by hydrocarbon and/or certain non-hydrocarbon fueled fires and the other bandwidth is selected so the first sensing channel is responsive to IR radiation emitted from hydrocarbon fueled fires. Both bandwidths are selected so the first sensing channel is essentially non-responsive to solar IR radiation.

E. Building Intelligence System
U.S. Pat. No. 4,567,557 (1986) to Martin J. Burns discloses a building intelligence system that is compact in construction and includes a single cabinet within which all of the operating components are housed. The system incorporates an uninterruptible power supply, a hard-wired input board, a relay output board and a power-line carrier transmitter output. A dedicated computer is programmable through a computer interface to provide a wide range of control to such functions as energy systems, security systems, appliances, lights and other electrical electro-mechanical systems that are present within the building.
U.S. Pat. No. 7,076,452 (2006) to Andrew C. Florance, John Stanfill, Craig Farrington, Mark Klionsky discloses a system and method for creating a unified commercial real estate data model through collection, distribution and use of information in connection with commercial real estate and for creating a web-based marketplace that facilitates the efficient and secure buying and selling of commercial properties. The invention provides a digital marketplace in which the members of the commercial real estate and related business community can continuously interact and facilitate transactions by efficiently exchanging accurate and standardized information.
U.S. Pat. No. 6,201,544 (2001) to Toru Ezaki discloses the development of a detailed map that is displayed on a display screen by using detailed map information. When a building BL on the detailed map is indicated, a user name list of the building is calculated from building information to display the user name list on a part of the display screen, and a detailed map MP displayed on another part of the display screen is inclined by a birds-eye process to be displayed. The indicated building BL is displayed three-dimensionally with a height corresponding to the number of its floors. When a user is specified from the user name list, the floor number of a floor on which the user is located is calculated from the building information. The floor is displayed by an L-shaped mark FL in the three-dimensionally displayed building such that the number of floors can be identified, and/or the floor number is displayed by the characters FLC.
U.S. Pat. No. 5,448,696 (1995) to Shigera Shimada, Fumio Kawamura, Kazuyuki Suzuki, Nobuyuki Chikada, Shirou Takei discloses a method for displaying information and system includes the steps of displacing map data on the screen of a display unit, displaying layout data representing one or more segments of a certain floor in each of the one or more structure elements of the map data displayed on a first designated portion, on a second designated portion of the screen in response to a layout display instruction, and displaying attribute data corresponding to each of the one or more segments of the floor.
U.S. Pat. No. 5,189,394 (1993) to Ronald Walter, Brian A. Chadwick discloses a computer-based display apparatus is provided for a fire alarm system having sensors located at various positions in a building or area. The display apparatus includes a computer with associated memory and display, as well as a facility for obtaining one or more screen images of the layout of the building or area from graphical representations of the layout, such as drawings, photographs or CAD generated data. The screen images are stored in memory for display on the computer display. The display apparatus also comprises a software facility for superimposing the positions of the sensors on the displayed layouts.

F. Fire Alarm and Alerting System
U.S. Pat. No. 5,838,242 (1998) to Gary C. Marsden discloses that this invention utilizes the modulation ratio between the flicker of a sensor signal and the absolute signal average to detect fire conditions. The system of the present invention requires that the signal on a sensor channel be above a certain threshold and the ratio of the flickering portion of the signal to the absolute signal average be within a certain range. The system may be applied to any sensor signal in response to any source, including, but not limited to, radiation, acoustic or optical signals including ultraviolet, visible or infrared radiation. Signals may be filtered with a median filter to remove noise. A least-mean-square curve-fit is made to the data to account for any growth or decay in the fire signal. The flicker can be calculated using any of several metrics such as standard deviation, p-norms, or maximum deviation, but mean deviation seems to provide optimal performance.
U.S. Pat. No. 4,725,819 (1988) to Koju Sasaki, Hirofumi Fujii, Seiichi Tanaka, Tetsuo Kimura discloses a fire sensing unit that is provided with apparatus which sends out a code identifying the type of sensor apart from transmission of the quantized signals of the analog output of the sensor of the sensing unit. Thus the data processing unit of the receiving unit of a fire detection system including the sensor can be simplified because the receiving unit need not collate the types of the installed sensors with a list of addresses stored therein. Also replacement of sensors can be easily effected since the information regarding the type of sensors is stored in the sensing unit.
U.S. Pat. No. 4,086,574 (1978) to Atsushi Miyabe discloses a fire detection systems where a timer sets an observation time. This may be accomplished by a first counter or shift register receiving a predetermined number of oscillator pulses. A second counter or shift register counts an alarm pulse produced by an AND circuit from the oscillator and the output of a fire detector. If the observation time expires before the second counter or shift register reaches its full count, the second counter or shift register is reset. If the second counter or shift register reaches its full count prior to the expiration of the observation time, the fire alarm is activated. Using this method, the system distinguishes a false alarm from the fire detector from the actual start of a fire.
U.S. Pat. No. 4,679,156 (1987) Mark T. Kern, Robert J. Cinzori discloses a fire sensor that can perform a sophisticated analysis of the outputs of radiant energy detectors, while minimizing size, weight, and cost, by employing a microprocessor to analyze the detector outputs. In one embodiment, an Intel 2920 Signal Processor is utilized as the microprocessor. An alternative embodiment incorporates an RCA 1802 microprocessor to achieve fire sensing while discriminating against false signal radiation.
U.S. Pat. No. 6,960,987 (2005) to Manabu Dohi, Masahiko Nemoto, Naoto Yamano, Hiroshi Shima, Naoya Matsuoka discloses a fire alarm system for connecting a plurality of fire sensors to sensor lines, and giving an alarm in response to fire information output from the fire sensor in a line unit. The fire alarm system includes a current modulation section and an address specification section. The current modulation section is used for maintaining a current flowing in the sensor line at a predetermined value for a predetermined time at the time of a fire, and modulating the current in accordance with the inherent address information of the fire sensor. The address specification section is used for sensing fire information by judging whether or not the current has been maintained at the predetermined value for the predetermined time, and also for specifying the inherent address of the fire sensor that issued the fire information, from the modulated state of the current.
U.S. Pat. No. 5,635,904 (1997) to Keiichi Takahashi, Atsushi Ohkawara discloses a fire alarm system having terminal units in a supervisory system for supervising a fire phenomenon, a receiving portion and terminal units in a control system to be controlled by the receiving portion that is able to reduce a required space in a case of a small size system. The terminal units in the supervisory system are given individual addresses, the terminal units in the supervisory system and the receiving portion communicate with each other through the addresses, and the terminal units in the control system are connected to the receiving portion through individual signal lines.

G. Location Detection and Display Systems
U.S. Pat. No. 5,867,257 (1999) to Robert R. Rice, Mark S. Zediker discloses a battlefield personnel threat detection system for identifying and analyzing vibrations corresponding to an immutable characteristic of a target of interest includes a transmitter for producing a transmit laser beam by amplification of a primary coherent laser signal, a coherent receiver responsive to backscattered light produced by interaction of the transmit laser beam with the target of interest and generating data corresponding to the immutable characteristic of the target of interest, and a control and display module for analyzing the data to thereby detect the presence of the target of interest and for controlling operation of the transmitter and the receiver. The target of interest can be an enemy soldier. In the battlefield personnel threat detection system, the control and display module permits the transmitter and the receiver to operate in an agile search mode of operation in which spectra indicative of the enemy soldier are produced.
U.S. Pat. No. 6,604,126 (2003) to Richard S. Neiman, Michael Parsons discloses a method of processing and displaying structural plans responsive to emergency tactical situations, the method including the steps of receiving a heterogeneous array of structural plan files, establishing a common specification for displaying structural plans, transforming the heterogeneous array of structural plan files to a standardized plan according to the common specification, receiving a remote request for a structural plan relating to a tactical objective, and responsive to the remote request transmitting the standardized plan to a remote recipient.
U.S. Pat. No. 6,535,121 (2003) to Richard K. Matheny discloses an alerting system for fire stations utilizes programmable message centers, zone-coded lighting and audio modules to alert only selected personnel for a particular type of emergency, i.e. fire, medical, etc. to decrease response time while reducing stress to remaining personnel who need not be alerted. Related features include night vision lighting, low level lighting, remote sensing and activation of station doors, ceiling mounted lighting signals, bed proximity audio alerts, automatic control of Emergency Response Facility audio sources and daisy-chain Ethernet cabling for simple installation.
Man Down Technology: A “man-down” device to detect when a first responder¹ such as a firefighter who is not responsive and needs assistance to be extracted from the structure. A man-down capability is embodied in a CodeBlue system that provides MoatTrack² information, i.e., first responder and tracking at a disaster site. Part of the CodeBlue system includes MoteTrack, a system for tracking the location of individual patient devices indoors and outdoors, using radio signal information. In MoteTrack, a hospital, clinic, or other area is outfitted with a set of fixed radio beacon nodes that are used to calculate the 3D position of the wireless sensors, which may be attached to patients, carried by physicians or nurses, or attached as “location tags” to medical equipment. MoteTrack has been demonstrated in a building-wide deployment at Harvard and yields an 80th percentile error of about 2 meters, which is more than adequate for many location-tracking applications. ¹ UCSD division of Calit2 all involved emergency-response technologies under development for ongoing homeland-security programs. Selena Salazar, Youn Woong Kim and Tanya Rostani, communicate information over Bluetooth to a first responder's cell phone² CodeBlue: An Ad Hoc Sensor Network Infrastructure for Emergency Medical Care, David Malan, Thaddeus Fulford-Jones, Matt Welsh, and Steve Moulton. International Workshop on Wearable and Implantable Body Sensor Networks, April 2004. (PDF)
Satellites Stand by High Above the Hot Zone: Exactly when and where the hot zone—the impacted area surrounding the precise spot where a weapon of mass destruction device is unleashed, i.e., Katrina—will suddenly appear is anyone's guess. What is certain is that 1st responders—fire, police and emergency medical personnel will be quickly activating their mass casualty incident management systems. In the process, satellite technology will be playing a vital role from the start.
Programs such as the Metropolitan Medical Response System, the multi-state Emergency Management Assistance Compact and the Disaster Management Interoperability Service (DMIS) are intended to ensure that resources flow to the scene and that the ranks of emergency response personnel on site are quickly reinforced. All of these programs are ready to roll with satellite technology. In an alternate embodiment of the invention DMIS would interoperate with LIC through an IP interface.
In the event of a terrorist attack on the United States, i.e., Katrina or the next Earthquake to hit California, emergency response and disaster management traffic will begin to flow. It may start with a noticeable up tick in satellite phone traffic, followed by a series of broadcasts over the Global Broadcast System (GBS) from the U.S. Northern Command headquarters at Peterson Air Force Base, Colo., via UHF Follow-On satellites. The Defense Satellite Communications System, Milstar and other Department of Defense and commercial satellite assets will be tapped by the Standing Joint Task Force Headquarters-North, responsible for overseeing the response by Northern Command, as it begins issuing commands to units across the country.
National Guard Civil Support Teams, created to assist local emergency commanders in the event of an attack using weapons of mass destruction, will deploy their satellite-equipped communications trucks known as Unified Command Suites and satellite-equipped sports utility vehicles known as Advanced Liaison Vehicles.
Satellite-equipped communications vans known as Infralynx, developed by the U.S. Naval Research Lab and pre-positioned in major cities across the United States will begin to roll. Equipped with the Ku-band Interim Satellite Incident Support Communications System, they will support the operations of a highly trained team known as the Chemical, Biological, Radiological, Nuclear or High Yield Explosive Enhanced Response Force Package with X-band satellite to provide secure command and control voice and voice conferencing capabilities all the way up to the White House. Ku-band, VSAT-equipped Mobile Air Transportable Telecommunications Systems and Mobile Emergency Response Systems may also be dispatched to the disaster scene by the U.S. Federal Emergency Management Agency (FEMA).
Sense-of-touch guiding system for 1^{st} Responder: Using wireless technology to assist the disabled is a passion for part-time Calit2 researcher John Miller, who mentored the ECE 191 team that worked on “Zigzag”—a computer-controlled, sense-of-touch guiding system for first responders. “In a real disaster situation, rescue workers may not be able to rely on their vision to get from point A to point B,” noted student Miho Nakao. “The Zigzag sense-of-touch guidance system will allow rescue workers to reach their destination safely while completing their task.”
The Zigzag group was co-sponsored by Calit2 and the NSF-funded RESCUE (Responding to Crises and Unexpected Events) project. The students constructed three different prototypes of the handheld gizmo using different input devices. The third prototype is computer-controlled and can integrate GPS-based “smart pointer” software and wireless technology to guide the rescue worker more effectively in an emergency situation.

H. Patient Tracking, Transport and Information Access in Collaborative Space
Ambulance of the Future: Life safety research efforts have been done elsewhere in the nation, but the CERMUSA FREC-M project was the first to target the specific environmental and technological challenges in the rural ridges and valleys of west-central Pennsylvania. The new ambulance is capable of providing continuous voice and data transmission through a variety of communications links, and has the ability to transmit and receive live video through a satellite video conferencing system. Saint Francis University's Center of Excellence for Remote and Medically Under-Served Areas (CERMUSA) was founded in 1994 and is based at the university's Loretto, Pa. campus. Principally funded by the United States Department of Defense through its Telemedicine and Advanced Technology Research Center (TATRC), CERMUSA tests, evaluates, demonstrates, and assesses “best practices” in providing healthcare services and education utilizing appropriate, available technology.
GUARD in New York City: In the aftermath of Sep. 11, 2001, the Fire Department of New York adopted Internet Protocol (IP)-based satellite technology as part of an intensive wireless communications upgrade. The department deployed Inmarsat Global Area Network terminals and service for video, voice and data connectivity for selected response vehicles and the Fire Department Operations Center and other fixed and mobile command centers. The department also is putting emphasis on live video, installing mast-mounted cameras aboard mobile command posts to provide high-resolution video feeds via the Inmarsat link.
In addition to the Global Area Network, a groundbreaking emergency communications project known as Geospatially-Aware Urban Approaches for Responding to Disasters (GUARD) has been developed. It came to life three years ago and taps into local public broadcaster Thirteen/WNET's Educational Broadband Service Band, a spectrum licensed to educational institutions, not-for-profit organizations and public broadcasters across the United States, to provide wider bandwidth than conventional emergency response communications systems. GUARD enables the integration of applications such as automatic vehicle location tracking, wireless electronic command boards, video all points bulletins for the New York Police Department and live mobile command and control video and audio monitoring. GUARD continues to evolve, with prototype testing of broadband wireless access technology and mobile capabilities underway.
Integration of wCare Assist with GE healthcare's DINAMAP® Pro 100-400 Series Vital Signs Monitor: Care Fusion, Inc. announced today that it has adapted wCareAssist™ to communicate with GE Healthcare's DINAMAP® Pro 100-400 Series vital signs monitors. Vital sign recordings are traditionally a cumbersome process, which often require manually entering the patient information several times on to paper charts before finally adding them into the Electronic Medical Record (EMR). Using wCareAssist with DINAMAP monitors will require fewer steps, allowing clinicians to directly and safely transfer the patient data into an EMR and without moving an entire workstation to the patients bedside. The application utilizes barcode technology to verify patient identification information.
wCareAssist™ runs on a handheld PDA device that has an integrated infrared interface with the DINAMAP. The clinician simply aligns the infrared ports, taps a button and the patient vital signs are downloaded from the DINAMAP ProSeries monitor to wCareAssist without manual transcription. Once the vital signs have been transmitted, wCareAssist provides clinicians the option to document detailed information related to the vital sign entry such as blood pressure location, patient position, body site of where pulse rate was taken, pulse oximeter readings, respiration descriptors and temperature details. When the clinician is finished documenting, the information is reviewed, confirmed and saved to the patient EMR. An optional module for entry of Intake and Outputs is also available with wCareAssist.
Care Fusion also offers wireless, mobile, barcode solutions for medication administration, specimen collection, blood transfusion verification and point of care billing. All applications are modular and available on a single PDA device.

I. Disadvantages of Prior Art

No prior art combines the aforedescribed processes into a single software system. Only the present invention enables a 1^{st} Responder in an emergency situation to leverage building intelligence to ascertain the location of victims, campus hot spots, as well as ascertain, in a non-intrusive way, the least risk ingress and egress paths to/from victim locations. Once the victims are evacuated to a triage point, the present invention continues to provide liaison service by enabling communications between 1^{st} Responder units at the triage point and the nearest trauma units, which enables quick response to save lives and property while mitigating risk.

### OBJECTIVES AND ADVANTAGES

The present invention facilitates the capture of victim location information and the acquisition of building intelligence. It uses this information to establish least risk access routes to the victims by identifying the coordinates of a victim and the conditions that surround the victim. It is an evacuation accountability system for building occupants that is deployable anywhere. The U.S. government identifies victim tracking as an imperative need following the disaster of Sep. 11, 2001.

The integration of victim information is also an Occupational Safety & Health Administration (OSHA) mandate. OSHA requires that an emergency action plan (EAP) be available at the disaster site and that it includes:
Evacuation procedures and emergency escape route assignments. The invention provides least risk ingress and egress routes in real time based on the situation encountered at the disaster location.
A procedure to account for all employees after an emergency evacuation has been completed. The invention provides victim location and accounts for all personnel.
Explicit rescue and medical duties for those employees who are to perform them. The invention enables 1^{st} Responder and Emergency Medical Teams to quickly reach and treat each victim, as well as contact all critical personnel.
Means of reporting fires and other emergencies. The invention automatically detects and communicates the situation to dispatch and to MCP unit.
Names or job titles of persons who can be contacted for further information or explanation of duties under the plan. The invention provides a repository for contact information.

In 911-type emergency situations, taking an action to facilitate the OSHA mandate is a significant undertaking. A real time building occupant location and evacuation system is needed. Both property management/owners and the 1^{st} Responders must begin to assess the impact of an incident. This assessment should include the number of occupants, their identity and current location in the emergency area, as well as egress and ingress routes. No prior art at a disaster site, in an unobtrusive way, is aware of these issues:
Who the victim is? The invention provides for biometrics index capture.
How many victims there are? The invention counts all personnel in or out of a building. Or
Where the victims are? The invention locates the victim in three-dimensional space and provides the 1^{st} Responder with victim location.
Nor do we know when a first responder becomes a victim? The invention tracks 1^{st} Responder in three-dimensional space and provides least risk ingress and egress paths.

The National Institute for Standards and Technology (NIST) developed 30 recommendations from the Worlds Trade Center (WTC) Collapse that has an impact on invention deployment. The extracted information specific to the invention includes the list below:
NIST Recommendation #19—NIST recommends that building owners, managers and emergency responders develop a joint plan and take steps to ensure accurate emergency information is communicated in a timely manner to enhance the situational awareness of building occupants and emergency responders affected by an event. This should be accomplished through better coordination of information among different emergency responder groups, efficient sharing of that information among building occupants and emergency responders, more robust design of emergency public address systems, improved emergency responder communication systems, and use of the Emergency Broadcast System (now known as the Integrated Public Alert and Warning System) and Community Emergency Alert Networks. The invention provides this intelligence and communication capability.
NIST Recommendation #22—NIST recommends the installation, inspection, and testing of emergency communications systems, radio communications, and associated operating protocols to ensure that the systems and protocols: (1) are effective for large-scale emergencies in buildings with challenging radio frequency propagation environments; and (2) can be used to identify, locate and track emergency responders within indoor building environments and in the field, The invention supports this protocol.
NIST Recommendation #23—NIST recommends the establishment and implementation of detailed procedures and methods for gathering processing, and delivering critical information through integration of relevant voice, video, graphical and written data to enhance the situational awareness of all emergency responders. An information intelligence sector should be established to coordinate the effort for each incident. The invention interoperates with other information systems via an Internet Protocol, Application Program Interface and it provides a composite picture of the situation.
NIST Recommendation #27—NIST recommends that building codes should incorporate a provision that requires building owners to retain documents, including supporting calculations and test data, related to building design, construction, maintenance and modification over the entire life of the building. Means should be developed for offsite storage and maintenance of the documents. In addition, NIST recommends that relevant building information should be made available in suitably designed hard copy or electronic format for use by emergency responders. Such information should be easily accessible by responders during the emergencies. The invention provides a data repository for this information that is easily accessible.

The invention therefore is unique because it is the only software solution that addresses all of the following legacy questions and incorporates the OSHA and NIST Recommendations:
Who is in the building now and where are they currently located? The invention counts all personnel in the building.
How do we identify all regular occupants or (guest) or transient individuals without being obtrusive or infringing on a person's privacy? The invention is non-intrusive, and in a disaster establishes identify using a biometrics index.
Does identification require use of biometrics scan? If yes, does this present a separate medical issue? The invention uses biometrics index, and presents no separate medical issue.
How do we track entry and egress of all people, animals (seeing-eye dogs)? The invention sensor system is designed to identify and track entry and egress of all people and animals, such as, seeing-eye dogs.
Who can or could have access to the information? The invention provides information access to any 1^{st} Responder or individual that has Health Insurance Portability and Accountability Act (HIPAA) Trusted Partner status.
How soon can the government agencies along with the 1^{st} Responder or property management see the information, once captured? The invention provides this information in real time.
How is the information made available? In total, in need to know portions, and are their security clearance issues that need to be addressed. The invention provides for separate reports for each individual authorized and authenticated to see the information and is governed by HIPAA regulation Trusted Partner Agreement.
Is the captured information available or stored in collaborative space how is it accessed? The invention captures the information in a database that is accessible via Internet Protocol (IP) through an Application Programmer Interface (API).
How is an individual occupant notified when a disaster occurs? Is this automatic or manual? In an alternative embodiment, the invention provides for connection to fire alarm and alerting systems that notify individual occupants. The invention provides automatic notification to 1^{st} Responder regarding the building situation.
What are the best evacuation routes based on the distribution of individuals by room and floor? This will be based on whether or not the threat is internal or external. How will you control mass evacuation and overloading of evacuation routes? The invention provides the 1^{st} Responder with the least risk ingress and egress path. The 1st Responder would convey evacuation path information to the occupants. In an alternative embodiment, the invention provides for connection to fire alarm and alerting systems that could be used to notify occupants of the situation prior to the arrival of the 1^{st} Responder.
What technology do each of the individuals involved have access to, i.e., cell telephone, pager, land line, fax line, Personal Data Assistant (PDA), Television, Radio, audio broadcast or visual broadcast per floor? Warden stations, standpipe telephones and other internal building systems. The invention, through a readiness process, captures and stores building intelligence, and ascertains the location of all technology available within a building that could be used to save lives and property. In an alternative embodiment the invention could provide for connectivity to many disparate technologies to ensure maximum dispersion of emergency information.
How does the command and control center work, i.e., similar to General Motors (GM's) ONSTAR or LOJACK? The invention provides a Legacy Integration Component (LIC) that promotes an Internet Protocol, Application Programmer Interface connection to a mobile command post (MCP). In an alternate embodiment of the invention MCP would connect to LIC via an IP interface. The MCP supports multiple frequency communications capability that includes voice recognition and audio mining as well as Internet Protocol. For example, Command and Control On the Move (C20™) applications that enable first responders to receive data-intensive information via satellite or down linked feeds, on the move.³ The personnel assigned to this MCP unit take direction from a single source. Under the provisions of OSHA these individuals are HIPAA trusted partners⁴ and are knowledgeable in the use of the invention. They have 24×7×365 access to the invention data warehouse. In an alternate embodiment the C20™ onboard LIC apparatus would have the address of each machine unit, its secure access code, and have access to the invention software application. The invention as described below is comprised of the LIC apparatus, application software including HIPAA compliant, high speed, file transfer capability, artificially intelligent workflow tools, Global Position Sensing spatial three-dimensional building topology⁵ referencing Building Intelligence Tactical System (BITS⁶) database, audio mining tools, the machine Event Alarm Sensor Tracking (EAST) geometry and victim coordinates, and access to an Internet Portal. Note that the LIC apparatus using this functionality may interoperate with health information technologies (HIT) such as electronic health records (EHR), to enable 1^{st} Responder access to data that helps identify victims and provide health history information at the triage point. ⁴ ES Enterprises Inc. Response to U.S. Department of Health and Human Services, Centers for Medicare & Medicaid Services, proposal CMSRFIOESSACl, Personal Health Records, dated Aug. 31, 2005, submitted electronically to Stanley Nachimson³ Utilizing new generation satellite antennae, designed for mobile platforms, C2O™ introduces tactical commanders with new capabilities to deploy their command elements to the most critical points, without loosing contact with their tactical operations center (TOC). Reference, http://www.defense-update.com/features/du-1-05/c4-onthemove.htm⁴ ES Enterprises Inc. Response to U.S. Department of Health and Human Services, Office of the National Coordinator for Health Information Technology, proposal Developing a Prototype for a Nationwide Health Information Network Architecture, Technical Proposal, dated Jul. 19, 2005, submitted to Program Support Center⁵ Google Earth puts a planet's worth of imagery and other geographic information right on your desktop. View exotic locales like Maui and Paris, as well as points of interest such as local restaurants, hospitals, and schools, http://earth.google.com/⁶ How to Create a Database File for a Building Intelligence Tactical System [BITS], JJM & Associates, dated Jun. 8, 2005
Who manages the technology, i.e., operations, maintenance and support? The invention is managed, operated and maintained by the 1^{st} Responder.
Who pays for the technology? The invention presumes that the 1^{st} Responder and/or building management would pay for the technology.
Who convinces the building owners, tenants and transient occupants to actively participate? The invention presumes that the buildings are adapted to support the invention during reconnaissance or building occupancy inspections.
Who trains the emergency responders to use the system? The invention presumes that the 1^{st} Responder and/or building management would be instructed on the use of the invention during the procurement process.

### Prior Public Disclosure

On Apr. 4, 2006, we publicly disclosed a brief and incomplete description of a technology that promotes sensing victim location and collecting building intelligence. However, this prior public disclosure only describes some of the basic functionality of the present invention. It did not disclose any of the details about the components and processes the present invention utilizes to perform this functionality. Nor does the prior public disclosure reflect any of following functionality of the present invention:

### SUMMARY, RAMIFICATIONS AND SCOPE

This invention provides a method, apparatus including a machine that helps 1^{st} Responders save lives and property during emergencies. The apparatus of the invention is comprised of an EAST Unit, a fire alarm system, a LIC Controller, housing BITS application and database, as well as processes and methods for promoting 1^{st} Responder effectiveness and efficiency. The connectivity between EAST Units and LIC may be via wireless communications. The system is made robust through the use of backup unit, battery power, and command and control vehicles that are made self sufficient in terms of communications and power. The method of the invention comprises processes that assist the 1^{st} Responder in controlling and containing a disaster, pandemic or terrorist attack, in reconnaissance, and in victim location and extraction.

In the preferred embodiment, the invention automates the following software enabled processes:
Management of EAST placement and testing,
Production of event characteristics and facility parameters, i.e., characteristics, such as, chemicals at the facility, the facility layout, location of power grids, water feeds and communications grids,
Notification of potential victims through alarm and alert components,
Victim location,
BITS analysis and site data presentation, and

In an alternative embodiment, the invention may automate the following software enabled processes:
Tracking of 1^{st} Responder from ingress to egress point.
Victim profile data collection and victim location via interoperating with health information technologies, such as electronic health records, or to access data that helps identify victims and provide health history information.

Although the descriptions above contain much specificity these should not be considered as limiting the scope of the invention but as merely providing illustrations of some of the presently preferred and various alternative embodiments of the invention. Accordingly, the invention includes all modifications and/or variations of the embodiments described herein with the scope of the invention limited only by the claims that follow.

### DRAWING FIGURES

The drawings present a composite view of the invention:

FIG. 1—LIC Controller, illustrates a block diagram of the apparatus of the invention

FIG. 2—LIC/BITS Database Design, illustrates a block diagram of the software application and associated database of the invention

FIG. 3—BITS Control Workflow, illustrates how BITS process enables 1^{st} Responders to maximize their effectiveness, i.e., saving lives and property, at an event

FIG. 4—Typical BITS Output, illustrates the information available to 1^{st} responder through BITS and presents a picture of a building three dimensional view used to ascertain victim and hot spot location

FIG. 5—EAST Sensing Unit, illustrates a block diagram of the machine, or stand alone fire alarm system

FIG. 6—EAST Coverage@60°, illustrates geometric arrangement of EAST machines to maximize coverage area and to facilitate positioning of victim (s) within a two dimensional space

FIG. 7—EAST Coverage Algorithm, illustrates how EAST machines are dispersed throughout a space to ensure coverage

FIG. 8—Typical EAST Output, illustrates EAST machine indexing, i.e., unique Internet Protocol (IP) addressing, and the least risk ingress and egress path to a victim, along with a location vector to a hot spot

FIG. 9—LIC Application Workflow, illustrates the invention process flows, RECON and Event

### REFERENCE NUMERALS

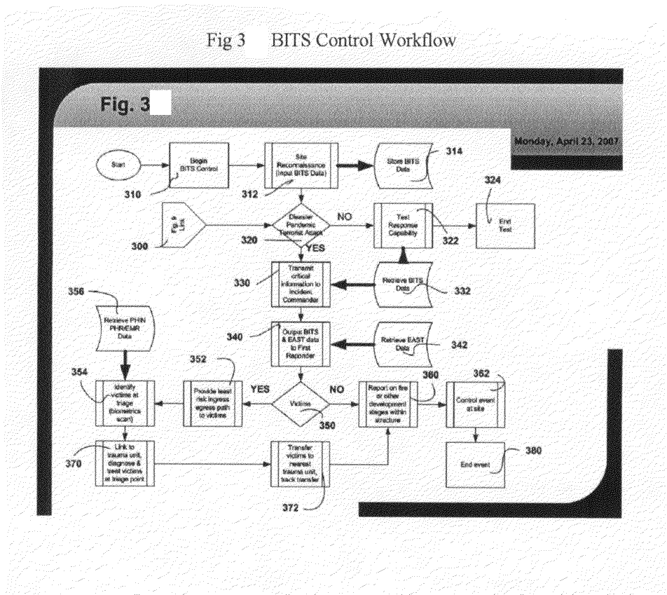

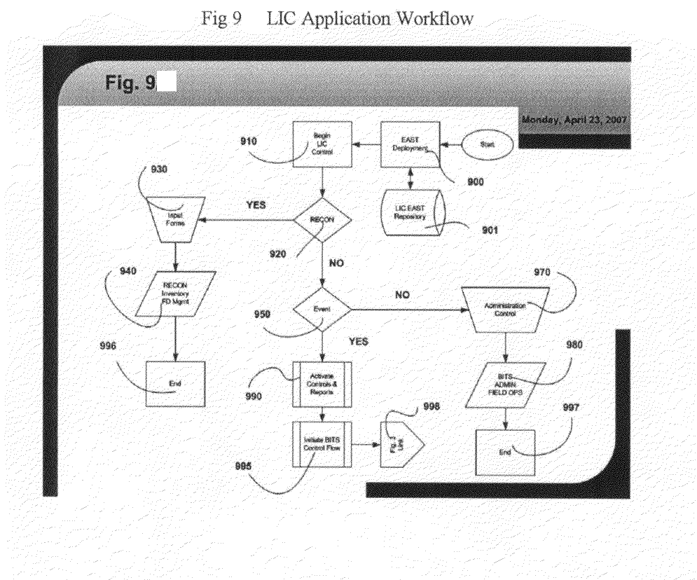

100 ROM Device
110 RAM Device
120 Input Device
130 Presentation Device
140 CPU
150 Output Device
160 Storage Device
170 Backup Device
180 User Interactive Interface Device
200 LIC Communication Panel
210 BITS
220 EAST
230 PHIN
211 Forms Input
212 Report Output
213 Relational Table
214 Program Code
215 Query Tool
300 FIG. 9 Link
310 Begin BITS Control
312 Site Reconnaissance (Input BITS Data)
314 Store BITS Data
320 Disaster, Pandemic, Terrorist Attack
322 Test Response Capability
324 End Test
330 Transmit Critical Information to Incident Commander
332 Retrieve BITS Data
340 Output BITS & EAST data to First Responder
342 Retrieve EAST Data
350 Victims
352 Provide least risk ingress egress path to victims
354 Identify victims at triage (biometrics scan)
356 Retrieve PHIN PHR/EMR Data
360 Report on Fire or other development or other stages within structure
362 Control event at site
370 Link to trauma unit, diagnose & treat victims at triage point
372 Transfer victims to nearest trauma unit, track transfer
380 End Event
410 Typical BITS Output (Fireground, Fire Protection System & Water Supply, Life Safety, Building T.I.P.S. Hazards, Building Data, Hazmat)
420 Typical BITS Output (Side, Sector, Sub-sector, Division)
500 Infrared Signal Processing Temperature Detection
510 Acoustic Signal Processing Atmospheric Pressure Detection
520 Communications Interface
530 Instrument Bus
540 Central Processing Unit
550 EAST Memory Unit
560 AC Power Supply Battery Pack
610-660 Hexagon Topology
710 Coverage Index
720 Estimated EAST units required
730 Circular Coverage (Map to floor area)
740 Rectangular Room Coverage
750 Outside Circular Circumference
760 Segment Area Subtended
770 EAST Units required
810 EAST Topography
820 Division (Map to EAST Index)
900 EAST Deployment
901 LIC EAST Repository
910 Begin LIC Control
920 RECON
930 Input Forms
940 RECON Inventory FD Management
950 Event
970 Administrative Control
980 BITS ADMIN FIELD OPS
990 Activate Controls & Reports
995 Initiate BITS Control Flow
996 End
997 End
998 FIG. 3 Link

### DETAILED DESCRIPTION

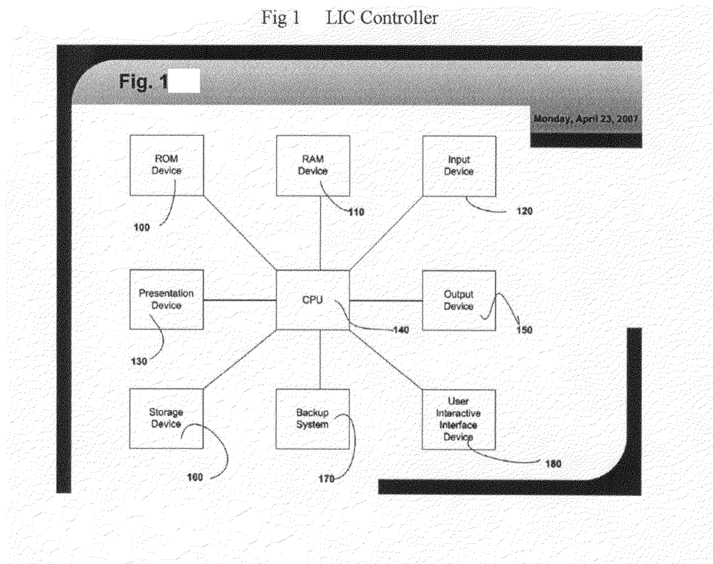

### FIGS. 1-9

The Figures below present the functionality, processes and reporting supported by the invention.

### A. FIG. 1

### LIC Controller

FIG. 1 illustrates a block diagram of the LIC Controller, an apparatus of the invention. The apparatus of the invention is comprised of a Central Processing Unit (CPU) 140 which is utilized for obtaining, processing, and reporting at least one element (unit) of data and information. The CPU 140 may operate in a microprocessor, a microcomputer, a mainframe computer, a supercomputer system, or a molecular computer depending upon the application and the digital computer system employed. The apparatus is also comprised of a Read Only Memory (ROM) device 100 for the storage of the operational program data or codes which control the operation of the apparatus and which is further comprised of any additional software programs or codes which direct the apparatus 140 to perform the method utilized in the invention. In this manner, the method of the invention may be embodied solely as a computer and/or software program or codes. A Random Access Memory (RAM) device 110 is also utilized for storing the data and information, which will be described in more detail below. Note that any other suitable memory method may also be used such as PROM, EPROM, and “bubble memory”. An input device 120 is utilized in the apparatus, which may be a keyboard, mouse, joy stick, optical scanner, electronic pen, modem, magnetic strip reader, LAN device, WAN device, touch screen, camera, touch pad, biologic measurement device, microphone, infrared device, ultrasound device or any other suitable means for entering data, information and user control commands into a digital computer system.

The apparatus is also comprised of a user presentation device 130 for presenting information related to the operation of the invention. In this respect, the operation of the apparatus may be facilitated by the display of on-screen menus, the sounding of audio speakers, and any other suitable means which may allow a user, via the user input device 120, to select apparatus operations or in other ways exert control over the invention. The presentation device 130 may also present requests for input information and/or data to the user in text, graphics, audio, video, multimedia, and any other suitable formats.

The apparatus is further comprised of an output device 150 which may be or which may include a printer and plotter for generating output data and information such as hard copy reports, an amplifier and speaker for generating audio representations of the data and information, a modem or other suitable telecommunication means for electronically transmitting output data and information or report data and information to remote locations, and other suitable output means for presenting data and information. The presentation device 130 may also function as an output device 150 by displaying a visual, audio, and any other suitable presentation of output data and information.

The apparatus is further comprised of storage device 160 which is made up of a hard disk, floppy disk, compact disk, magneto-optical drive, tape drive, magnetic strip, or other suitable means is used for storage of data and information in digital form.

The apparatus may also comprise a backup system 170 which is made up of a CPU 140′, a ROM device 100′, a RAM device 110′, and storage device 160′, which are identical to the CPU 140, the RAM device 110, the ROM device 100, and storage device 160, respectively, described above. The backup system 170 serves as a redundancy system in the event of a failure or malfunction of any of their primary system counterparts (CPU 140, ROM device 100 and RAM device 110, and storage device 160, respectively). In this manner, duplicate files may be stored.

The apparatus may also comprise a user interactive interface and delivery system 180. The user interactive interface and delivery system 180 may be a separate computer (not shown) which may contain ROM and RAM memory devices, data input and user command entry devices, which may include a keyboard, a mouse, and/or a modem or any other suitable device, and a data output device which may be a printer or any other suitable device for obtaining, receiving or storing data output reports. The user interactive interface and delivery system 180 is designed to be utilized by remote users and is further designed to be located at remote locations such as at the locations of the above described users. The user interactive interface and delivery device 180, may be interfaced with the apparatus of the invention either via telecommunication means and/or other suitable communication networks which may include direct communication link-ups and/or radio communication link-ups via transmitting and/or satellite communication systems or means.

The user interactive interface and delivery device 180 provides a means by which to allow a remote user, as defined above, to access the apparatus. This may allow for a direct transmission of data and information to be entered via any suitable data entry means located at the user's location. It should be noted that adequate precautions are to be taken so as to prevent an unauthorized user from accessing the apparatus and the data, information, or algorithms stored therein. Information reports are electronically transmitted to the user via the user interactive interface and delivery device 180 wherein the report or reports may be output via the output means (not shown), which may be a printer or other suitable output device, or wherein the report data may be stored in a user memory device.

Utilization of the user interactive interface and delivery system 180 may be accompanied by a security scheme or means whereby the user may be required to input a user password or access code in Order to access the system and/or decrypt data and information that has been previously encrypted. Any other suitable security system may also be utilized to safeguard the apparatus of the invention as well as a user's files and/or other interests. The security scheme or means may also be provided to ensure security and confidentiality of data and information. Further, the device 180 allows for an expedited data and information entry process as the data and information may be entered directly and/or instantaneously into the apparatus.

Further, the apparatus of the invention may be adapted to service multiple users over multiple channels in a network environment such as in local area networks (LANS) as well as wide area networks (WANS) wherein the invention may be utilized over communications and/or long distance communication lines or systems such as telephone networks (phone lines) and/or radio communication and/or satellite communication networks.

Further, the user interactive interface and delivery system 180 may be employed to allow a user access to unsecured databases, or portions thereof, which may be stored in the apparatus or which may be used in association with the invention. The user interactive interface and delivery device 180 therefore may also provide for a means by which the invention may be utilized as an on-line database. In this manner it can be seen that the invention, which may be utilized in conjunction with network systems described above, can be utilized for providing vast amounts and varieties of data and information.

The CPU 140 operates under the control of the system operational software that is stored in the ROM memory device 100. The operational software of the apparatus, as will be described in more detail below, provides for complete control over the operation of the method of the invention. The operational software may be provided in any programming language or it may be implemented in assembly or assembler language for the particular microprocessor or CPU utilized, depending upon the digital computer or processor utilized as well as depending upon any of the specific application constraints.

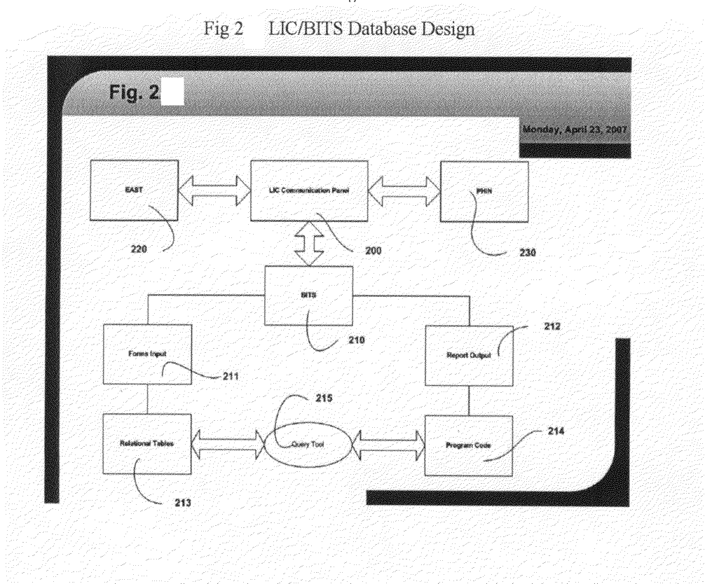

### B. FIG. 2

### LIC/BITS Database Design

As depicted in FIG. 2, LIC apparatus, a platform, software application and database, is the technology used to ascertain the geospatial signature of the occupied building and deduces the location of each victim. LIC Communication Panel 200 demonstrates the relationship between LIC and BITS. LIC passes control to BITS to enable the 1^{st} Responder to obtain building intelligence.

In an alternate embodiment, LIC may interoperate with health information technologies, such as the Patient Health Information Network (PHIN) module 230 or other such electronic health record systems, to enable access to data that helps identify victims and provide health history information. To enable access to such technologies, LIC would uses an Internet Protocol, Applications Programmers Interface, and/or other appropriate means.

The LIC interface to Building Intelligence Tactical System (BITS) occurs via ACCESS Command Button.

1. BITS Application & Database

The integrated BITS application and database is accessed via the LIC Communication Panel 200. LIC/BITS Database Design illustrates how BITS operates by leveraging the BITS Master Control Board 210. This is a computer-based program and database designed to provide the fire service with decision-based data about the on campus buildings within their response areas. Today, the outside building appearance may give little or no clue as to the actual construction, building contents and distinctive building hazards that may lead to an erroneous, if not deadly, assumption as to how a building will respond under fire attack. The BITS program shows the importance of obtaining critical building intelligence, such as the value of a decision-based size-up:
Occupant life safety concerns; building data such as roof and floor structural members,
Exterior obstructions,
Hazardous material dependencies,
Fire protection systems and water supply as well as the building characteristics that are unique to one specific structure, etc.

The BITS application and database incorporates several relational tables 213 that include Fireground, Water Supply and Fire Protection Systems, Life Safety, Building T.I.P.S. Hazards, Building Data and HAZMAT information. The Forms Input 211 provides for all data collection at a site indexed by Side, Sector, Sub-sector Division or Floor. Each level of the building is identified and the knowledge of what is outfitted with the specific fire equipment and evacuation structure is introduced to BITS prior to an event. BITS output reports 212 provide direct access to this information indexed by Building Name, Side, Sector, Sub-sector and Division or Floor. BITS Program Code 214 enables unique addressing of the site by number, name, or street name. The Query Tool 215 enables direct access to the relational tables for specific information, e.g., all buildings with wood floors and hazardous chemicals.

### C. FIG. 3

### BITS Control Workflow

FIG. 3, BITS Control Workflow is activated via LIC Application Workflow when an event occurs at step 300. LIC Application Workflow will be introduced in the section titled The Invention an Integrated System. BITS Control Flow allows for BITS control to be initiated at step 310. To promote Site Reconnaissance, the 1^{st} Responder ensures that the most recent BITS data is identified and catalogued at step 312. To ensure that the most recent BITS data is in the BITS database, the 1^{st} Responder uses the BITS application to write the data into the database at step 314, which is labeled Store BITS Data. The BITS form, Forms Input 211, is used to enter the BITS data. It is complete in its description of a structure or campus and it is a facsimile of the paper forms used by fire fighters today. This electronic input form includes all of the data elements needed to populate the BITS database. The input form includes Fireground; Water Supply and Fire protection Systems; Life Safety; Building T.I.P.S.; Building Data; HA MAT; and Responsible Department. If an emergency event is in progress, BITS Control Flow, at step 320, passes control to the BITS application at step 330, where the Incident Commander is presented with the needed building intelligence. On route to a disaster, pandemic or terrorist attack, a First Response Unit Command and Control vehicle (MCP) commander would select the particular Fireground based on input from dispatch.

Once selection information is entered into the BITS application, the person in charge prepares tear sheets and presents the First Response Team with their objective. The output report that relates to the structure or campus environment the First Response Unit will encounter is incorporated onto a letter size document. All reports pertinent to the objective are noted with situation specific information and presented prior to accessing the structure or campus. With the 1^{st} Responder approaching the site event, LIC ensures that all pertinent BITS data are made available in real-time to the 1^{st} Responder at step 340. Upon arrival at the disaster site, the 1^{st} Responder assisting with search and rescue ascertains if victims are part of the event at step 350. If they are, the 1^{st} Responder proceeds at step 352 to identify the least risk ingress and egress path to the victims based on the triangulation performed by LIC software.

In an alternate embodiment of the invention, the victims are identified at the triage point at step 354. A communications link is made to a trauma unit at step 370 to assist with initial diagnosis and treatment of the victims. With the victims stabilized at the triage point, they are prepared for transfer to the nearest trauma unit able to meet their respective healthcare need at step 372. After stabilizing the victims at the triage point, they are prepared for transfer to an appropriate trauma center at step 372. Victims able to be moved are then taken to the trauma center. In an alternative embodiment, the 1^{st} Responder would obtain victims' identification and health information via the PHIN interface at step 230. The PHIN interface would be used to track the transfer and present victim health information to the trauma center upon arrival. With the victims' problems satisfied, the 1^{st} Responders focus on gaining control of the situation at step 360.

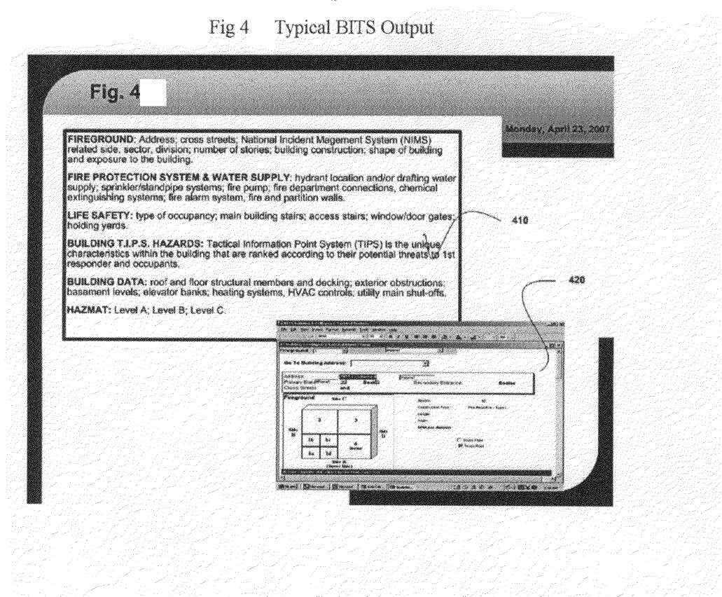

### D. FIG. 4

### Typical BITS Output

The BITS is the only computer-based program designed to provide the fire service with decision-based data about the buildings within their response areas. BITS provides the following functions and features:
capture, query and reporting of site specific building inventory residing in a three dimensional space,
capture, query and reporting of information pertaining to address, cross street National Incident Management System (NIMS) side, sector, division, number of stories, building construction, shape of building and exposure to the building,
capture, query and reporting of information pertaining to hydrant location and/or drafting water supply, sprinkler/stand pipe systems, fire pump, fire department connections, chemical extinguishing systems, fire alarm system, and fire and partition walls,
capture, query and reporting of information pertaining to type of occupancy, main building stairs, access stairs, window/door gates, holding yards,
capture, query and reporting of information pertaining to tactical information point system (TIPS) ranking, identifying potential threats to 1^{st} Responder and occupant,
capture, query and reporting of information pertaining to roof and floor structural members and decking, exterior obstructions, basement levels, elevator banks, heating systems, Heating Ventilating and Air Conditioning (HVAC) controls, utility main shut-off valves,
capture, query and reporting of information pertaining to Level A, B, C HAZMAT locations.

In FIG. 4, the Typical BITS Output 410 illustrates the type of information provided to the 1^{st} Responder, which may include FIREGROUND, Water Supply & Fire Protection System, Life Safety, Building T.I.P.S. Hazards, Building Data, and HAZMAT. An example of the Fireground report lists specific structural aspects needed to ensure safe access to the structure or campus. The BITS system provides fifteen such output reports: Inventory; Building Data; HVAC Controls; Fireground; Roof/Floor; Utilities; Water Supply FPS; Elevator Obstructions; Emergency Contact; Life Safety; Elevator Type; HAZMAT; Building TIPS; Heating System; FD Management.

The illustration 420 introduces the geometry used to locate machine units and fire safety equipment dispersed throughout the building (discussed in section EAST Machine below), fire safety inventory, ingress and egress routes, and victims in an event using Side, Sector, Sub-sector, and Division or Floor identifiers. A typical output from BITS used by 1^{st} Responder to influence decisions at the event is illustrated at 420. By leveraging this intelligence, reported by BITS, the Incident Commander adjusts fire ground tactics and gives firefighters confidence that they are searching in the right spot, and it diminishes the chances of a firefighter becoming a disoriented victim.

1. BITS Administration

The BITS administration function is supported to enable easy access to records for the purpose of maintaining the BITS database. It is critical that the readiness-state of the database be at the highest level. The key tables in the BITS database include: Address-Fireground; Building Data—Structure, Obstructions; Water Supply and Fire Protection Systems; HAZMATS; Building Data—Elevator, Heating, HVAC; Building Photos; Building Data—Utility, Contacts; Building T.I.P.S.; High Rise; Life Safety; External Obstructions; Utility Mains. A database analyst acting on behalf of the First Response Unit would maintain these tables. These records are automatically updated during BITS RECON activity at step 312 in FIG. 3, or may occur at the machine install, or during a building occupancy review, or periodically when building inspections are conducted.

### E. EAST Machine

EAST will count individual persons entering or leaving its location. Its location would be known to LIC and integrated with BITS information at an event site. Multiple EAST units would be deployed at a site. LIC would integrate the feedback from the EAST units in real time, via the User Interactive Interface Device 180. The Present invention would process EAST output at step 342, leveraging the communications interface, along with BITS input, obtained from the BITS database at step 332, and build a three-dimensional composite of the victim situation. The composite would be displayed at the Command and Control vehicle, MCP. LIC would use a triangulation algorithm to triangulate victim locations and EAST would use rise and fall measurements to ascertain distance from the EAST unit to the victim. BITS data would be integrated with EAST data to ensure least risk ingress and egress. A map identifying least risk ingress and egress routes would be developed by LIC for use by a 1^{st} Responder.

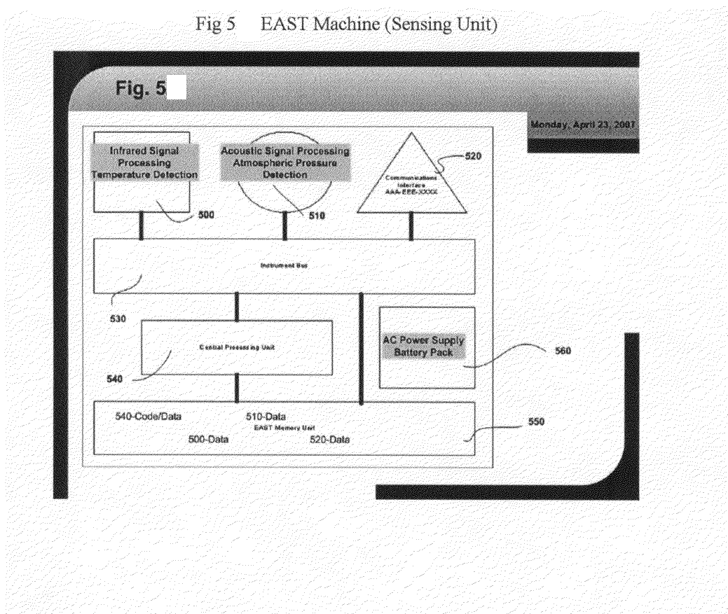

1. FIG. 5: EAST Machine (A Sensing Unit)

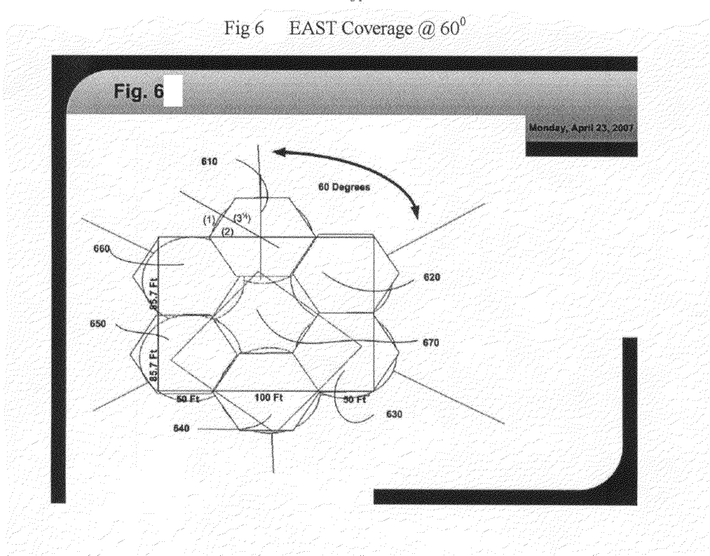

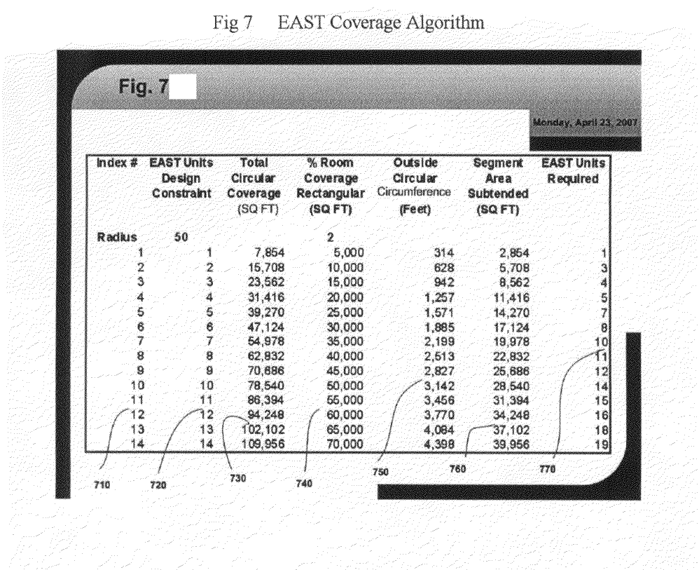

FIG. 5 depicts how the EAST machine, Sensing Unit, is constructed as a stand-alone fire alarm system. This machine provides sensing of temperature and pressure, victim location data and communications via a wireless interface. The EAST infrared sensor is used to detect hot spots and to count individuals as they pass through the field of view of the sensor depicted in FIG. 6. The EAST acoustic sensor array provides further discrimination of human vibrations. Hence, EAST is able to identify how many victims there are and their locations. EAST units would be mounted in specific locations within a facility, e.g., a mounting location equal distance from all surfaces as indicated by the EAST coverage algorithm depicted in FIG. 7. The anticipated range for passive monitoring of traffic would require that a victim be within fifty feet of any EAST unit, thus leveraging signal processing from an omni-directional detection array supporting a radius of fifty feet. Returning to FIG. 5, the EAST unit includes:
passive infrared signal processing and temperature detection 500,
acoustic signal processing and atmospheric pressure detection 510
communications Interface 520
an instrument bus 530,
central processing unit, 540,
EAST memory unit 550, and
AC power supply and battery pack 560

EAST works in the following way:
A signal is detected by the infrared signal processing and temperature detection circuitry or the acoustic signal processing and atmospheric pressure detection circuitry,
Peripheral device 500 and 510, sensor recognition circuitry, output data regarding signal strength and angular position is captured and routed via the instrument bus to the EAST memory unit 550 at a location in memory previously programmed into the EAST unit.

Programming for the EAST unit is provided by the central processing unit (CPU) 540. Programming code to operate the central processing unit is stored in EAST memory until accessed by the central processing unit. EAST Unit CPU links to LIC via the communications interface 520. This communications is wireless. The AC Power Supply 560 provides power to recharge the Battery Pack. The EAST Unit runs on Battery once an event occurs, hence it is not dependent on site power during an event. East Memory unit 550 is designed to hold thirty minutes of data prior to and during an event occurrence, a total of one hour of data. During normal operations, non-event, data is overlaid. The EAST unit supports a bus connection to EAST memory unit for the CPU, black line between item 540 and 550, and a bus connection to EAST memory unit from the instrument bus for each of the peripheral devices, black line between item 530 and item 550. The instrument bus 530 supports four additional connections, 500 to 530, 510 to 530, 520 to 530 and 530 to 540. Thus enabling concurrent data storage and code execution.

EAST peripherals, item 500, 510 and 520, are uniquely addressed and connected to the central processing unit and memory by an eight-bit instrumentation bus that provides for data transfer and control. Each device on the bus, EAST peripheral, has a unique address. Each device on the bus is buffered. Input and output to a device is a stream of data of fixed length. Each device can interrupt the central processing unit. The central processing unit will provide a read and write buffer for each device on the instrumentation bus. In the unusual case that an interrupt collision occurs a round robin read write cycle is started by the central processing unit. The central processing unit stores the output of peripheral 500 and 510 in memory using a linked list that is addressed by an interrupt vector. The processor operating code provides for interrupt processing using a push and pop stack. The EAST peripherals constantly update the central processing unit with real-time data via EAST memory. The central processing unit algorithms translate this raw data into traffic count, victim count and location information. In case of an event, hot spot detected or EAST unit failure, the central processing unit receives a signal from the detector and awakens the communication module to dial-out to a predefined alarm location. With no activity stream from the detector or communications unit the central processing unit idles by executing a continuous branch instruction waiting for an interrupt to occur. The detectors continue to cycle and overlays the last data captured. The battery onboard EAST is rechargeable. It sustains the EAST unit for at least 30 minutes after building power is lost, i.e., assumed to be 110 Volts AC. Each EAST unit has a geospatial location transponder built into the communications module. Hence, the location of each device even if it is dislodged from its moorings is locatable.

Feedback from this novel Event Alarm Sensor Tracking (EAST) hardware device, that is strategically placed within a building and integrated with EAST software of which there is no prior art, supports 1^{st} Responder decision support. EAST software includes tables that are specific to EAST and include sensor location data, sensitivity data, ten-digit wireless access code, and triangulation algorithm to uniquely identify the location of every potential victim. The triangulation function relies on an algorithm that uses the relationship between displacement, velocity and acceleration at the interface to the sensor device to establish signal strength. These signal strength measurements are a function of sensor sensitivity, propagation and spreading loss. The signal strength is translated into a distance and an angle to uniquely place the victim a precise distance from the sensor. It requires the output from at least three EAST units to properly identify the location of a victim or to track victims through the building.

Each EAST unit will have a unique ID. It is quite possible that a 1st Responder with a hand held device sensitive to RFID transmission would be able to locate an EAST unit by this ID. Hence making it easier in a smoke or fire to locate victims, navigate the premises and promote safe ingress and egress. EAST hardware is wireless, provides needed situation awareness data, and automatically links to a LIC application via a wireless interface to unobtrusively, track and account for all employees/victims during a disaster and after an emergency evacuation has been completed. The EAST unit provides the following event specific function and feature:
Passively monitor situation within fifty foot radius of sensors,
Passively locate and register all human traffic passing within fifty foot of sensor including 1^{st} Responders,
Processing and storing situation assessment information in memory for later readout by LIC,
Memory readout when polled by LIC, EAST units communicate situation awareness and victim data directly to the Legacy Integration Component (LIC) using Internet Protocol via a wireless connection.

2. FIG. 6: EAST Coverage@60°

FIG. 6, East Coverage@60° illustrates the hexagon style of distribution used for installation of EAST Units. This design is critical to the successful calculation of victim location. The hexagon provides for maximum coverage and minimal numbers of EAST Units thus holding down installation investment. All hexagons are identical in size with one EAST Unit per hexagon. The center to center distance, between locations 610 and 620 is 100 feet and the distance from the center to any of the six sides of the hexagon is 25(3)^{1/2} and each hexagon within the 50 foot radius circle establishes a search space outlined by a equilateral triangle 50 foot on each side. The sensitivity for each of the EAST Unit detectors is identical. Hence, the sensors in hexagon at locations 610, 620, 630, 640, 650, 660 and 670 would report identical signal levels for a target placed an equal distance from each EAST unit. Signal strength is a direct measure of the distance to the target as measured from the center of the hexagon or the location of the EAST Unit, signal strength decreases, function of spherical spreading, by a fixed amount for every doubling of distance. Therefore, with three EAST units reporting signal strength, i.e., distance and angle to the target, on a given target, it is possible to ascertain the exact location of the target or the victim as referenced by a specific point in the room. LIC maps the room coordinates using BITS input regarding the location of the EAST Units and in so doing identifies the exact location of the victim through triangulation.

3. FIG. 7: EAST Coverage Algorithm

In FIG. 7, the EAST Unit Coverage Algorithm is designed to promote the least number of EAST Units per square area. The algorithm considers the total area of the hexagon and the total area of a circle that has a fifty foot radius and the area to be covered, i.e., sensitivity pattern of the detectors, to determine the actual number of EAST Units required to adequately map the space. Column 710 is an index into the record to identify a particular size room and column 720 is the estimated number of EAST units. The square foot coverage anticipated by one through fourteen units is presented at column 730. Column 740 represents rectangular coverage area and column 750 represents the outside circumference of the coverage area. These different measurement approaches enable the 1^{st} Responder to relate EAST placement to different building designs. The segment area that exists outside the hexagon is depicted at 760. This area is the difference between the rectangular coverage, 740 and the total circular area at 730. Once the difference is calculated for a particular design the actual number of EAST units can be calculated or ascertained from the table at column 770.

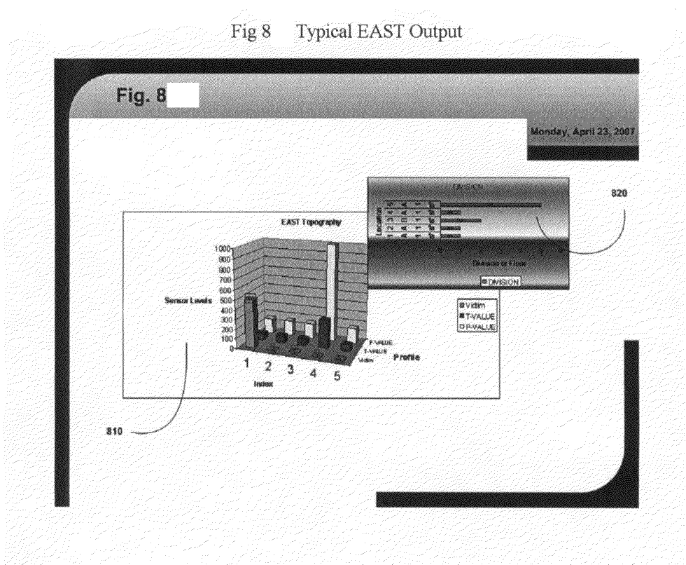

4. FIG. 8: Typical EAST Output

Typical EAST output, depicted in FIG. 8, identifies the exact location of a victim. These locations would appear on a grid with directional guidance provided to the 1^{st} Responder. In FIG. 8, Typical East Output 820 illustrates the addressing associated with uniquely identifying the location of an EAST Unit, index 1-5. Item 810 illustrates the location of the EAST Unit by unique ID, the location of the victims, high pressure and temperature or hot spots on a particular division or floor. With this intelligence available the 1^{st} Responder can ensure their safety, can navigate the building safely, and reach the victim in the shortest time using the safest route. As the situation changes EAST continues to monitor the situation and provides an electronic means for aiding 1^{st} Responder decisions in response to changing conditions.

5. EAST Operations

The deployment of EAST, as depicted in FIG. 6, is similar to the deployment of fire alarm devices in buildings today. Step 312 in FIG. 3 depicts what is done when a 1^{st} Responder does reconnaissance by inspecting buildings for fire safety violations and/or to update BITS database. The 1^{st} Responder ensures that the building is outfitted with the proper number of EAST units, as depicted in FIG. 7 column 770, Index row 5, the 1^{st} Responder needs, dependent on geography, 5 to 7 units for a room approximately 171 by 200 feet or about 34.3×10³ square feet. The 1^{st} Responder ensures that the EAST units are properly positioned in the building, as depicted in FIG. 6, hexagon 610-670 demonstrate that the room, noted above, requires a minimum of 7 EAST units. The invention assumes that EAST will be installed by certified installers following a plan developed by a licensed architect, engineer or EAST designer. Following installation using manufacture instructions each EAST unit would be programmed and inspected by the 1^{st} responder. In an alternative embodiment, the install would be done by the building management and certified in writing that the inspection has been done in accordance to the prescribed plan and the outcome of the inspection meets the requirements of the EAST manufacturer installation instruction. A licensed contractor who would file a report with the building management could perform the installation work. The building management would them forward a final report to the Jurisdiction in charge (JIC). A penalty program would have to be spelled out in advance.

### F. The Invention

### An Integrated System

As the USA moves, incrementally, toward a visible, homeland security posture, it requires integrated systems. The present invention meets the needs of a 1^{st} Responder in an emergency scenario. This scenario could include a disaster, pandemic or terrorist attack. Whenever 1^{st} Responders are dispatched to a disaster the Legacy Integration Component (LIC) of the invention is used as the tactical control system, integrating components and enabling 1^{st} Responder Units to save life and property.

1. FIG. 9: LIC Application Workflow

In FIG. 9, LIC Application Workflow begins at step 910. At step 910 the LIC controller is activated. LIC assumes that EAST Units are deployed, are in the process of deployment, or actively involved in an event. All campus facilities are mapped in BITS, are in the process of being mapped, or actively involved in an event. With new EAST Units being deployed LIC at step 920 would open Input Forms at step 930 to begin the RECON Process, whereby all buildings and their fire safety features would be inventoried by Fire Department Management teams at step 940. The RECON process ends at step 996. If an event occurs BITS is activated at step 950. The Controls and Reports become available at step 990 and the 1^{st} Response Unit would Initiate BITS Control Workflow, at steps 995 and 998 as they approach the disaster, pandemic or terrorist attack site. If the Administration Control personnel are not processing a new location or managing an event the invention provides for Administrative Control activation at step 970, for purposes of maintaining the operational status of EAST/BITS. The process involves BITS Administration and Field Operations updates at step 980. This work has a defined end at step 997.

Two additional processes are supported by the invention, using BITS data and EAST machine data to enable 1^{st} Responder to gain control of the event at step 362, and ensuring that life and property are secure at step 380. These two elements end the BITS Control Workflow. At an event, the 1^{st} Responder reviewing BITS output passes control back to LIC for production of ingress and egress route maps using EAST data that maps to BITS presentation of Side, Sector, and Division or Floor. The communications path between LIC and EAST and/or PHIN will be wireless. The interface is a communications interface using IP connectivity, i.e., Transmission Control Protocol-Internet Protocol, accessed via a Hyperlink control to PHIN 230 and EAST 220. The EAST spatial geography, X, Y and Z coordinate is maintained in the EAST Memory Unit, the EAST CPU reads out this data during an event, passes it to the communications interface for transmission to LIC. Once the data is received by LIC it is made available for integration with BITS data using LIC application software. The integration of BITS and EAST data by LIC produces a three-dimensional image of the location of each hot spot and location of each victim or man down.

In an emergency, a command and control vehicle, earlier referred to as a MCP, with LIC on board will call the EAST communications module-requesting download of all information currently in memory. LIC will continue to download all EAST units on site until they fail due to power failure. During an emergency, a round robin read write sequence would be enabled. LIC will have sufficient communications channels to receive transmission from all EAST Units.

In an alternative embodiment, other communication media could be used to connect the invention to disparate technologies, which depends on the communications unit, such as radio transmission, satellite transmission, or other means as appropriate. In addition, the IP interface of LIC could be used to obtain EMR data through PHIN or other EMRs.

LIC supports multiple input channels to ensure that it can rapidly cycle through all EAST units deployed at a given location. Using a triangulation algorithm, LIC software translates the sensor information into X, Y and Z coordinates and indexes victim location by Side, Sector, Sub-Sector, and Division or Floor. LIC then constructs a three-dimensional image of the floor with ingress and egress paths developed in real-time using building intelligence extracted from the BITS database. This information is then provided to the 1^{st} Responder at the scene.

2. LIC/EAST Integration

The EAST units, when read via the LIC system provide the needed information regarding victims, hot spots, and high-pressure areas. The LIC software reads the East Units as the First Response Unit is on route to the scene. The East Units identify the location of victims and the 1^{st} Responder, the temperature at each location by Division or Floor, and provide the pressure associated with a specific location. The index provides a direct link between the East Unit and the map of the building in question. Hence, Command along with the 1^{st} Responder can ascertain in real-time the least risk route to the victims, the number of victims, and the least risk route away from the trouble area. As the situation changes, the LIC Output Device 150, upon receiving notification from EAST, alerts the Incident Commander of the changes. Each East Unit has a geospatial address and a unique, secured, electronic address, similar to a telephone number or computer Internet address that is only known to the LIC system. Hence, identification of 1^{st} Responder ingress and egress path is reported in real time using the intelligence gathered through EAST reporting.

3. EAST/BITS Integration

Maintenance and testing of EAST units will likely be the responsibility of the 1^{st} responder or contractor. Maintenance of the BITS database will likely be the responsibility of the 1^{st} Responders. When EAST victim location data is integrated with BITS building intelligence data, egress and ingress paths are indexed by Side, Sector, Sub-sector and Division or Floor. The invention automates the following software enabled processes:
Victim profile data collection, and victim location,
Management of EAST placement and testing,
Production of event characteristics and facility parameters, i.e., characteristics, such as, chemicals at the facility, the facility layout, location of power grids, water feeds and communications grids,
Tracking of victims from an event through triage and eventually to hospital or morgue,
Notification of potential victims through alarm and alert components,
PHIN PHR/EMR access,
BITS analysis and site data presentation,
Tracking of 1^{st} Responder from ingress to egress point, and
In an alternate embodiment, acquisition of victim profile identification, presentation of patient history, and other information would be obtained from the PHIN PHR/EMR and/or other health record systems.

4. Least Risk Ingress and Egress

Least risk implies that the 1^{st} Responder has minimized his/her vulnerability to the threat of an explosion, cave-in, back draft, or building collapse during a search and rescue, Returning to FIG. 8, at step 810 shows such a path to Index 1 location. This level of building intelligence provides for secure access to the victim ensuring that the 1^{st} Responder search and rescue occurs without incident and that search and rescue leverages as much building intelligence as possible. The only way for this to happen is for EAST Units and BITS application and database information to be integrated together in a LIC environment.

5. Reconnaissance

In an alternative embodiment, BITS data would be captured for all buildings independent of EAST Unit disposition. Once EAST Units are installed, an electronic file is generated and uploaded to LIC via an Internet portal for subsequent download to all related LIC facilities. In an alternative embodiment, the EAST information regarding location and access of each unit would be transmitted to LIC facilities via communications enabled PDA laptop, notebook, or clipboard electronic pen. Returning to FIG. 9, this information would reside in a LIC data warehouse, i.e., 1^{st} responder LIC EAST information repository 901. The repository is a mandatory component. Compliance would be ensured through a check of the repository prior to the issuance of a building occupancy permit or during subsequent inspection.

6. Generating Reports

EAST/BITS provide the data to generate the following reports at 410 in FIGS. 4 and 810 in FIG. 8:
Fireground would include but is not limited to the following information: Address, Primary Entrance, Cross Street, Secondary Entrance, Side, Sector, Division, stories, construction, shape, and exposures.
Water Supply & Fire Protection would include but is not limited to the following information: Hydrant locations and fire alarm main panel.
Life Safety would include but is not limited to the following information: Occupancy load, Stairs (interior and exterior), and NFIRS code
Building T.I.P.S. Hazards would include but is not limited to the following information: location of ground level obstructions and above ground vessels
Building Data would include but is not limited to the following information: Roofing, access, flooring, basement access, heating system, emergency shut-off, fuel tanks, utilities, emergency contact personnel and telephone number
HAZMAT would include but is not limited to the following information: specific level and access to personnel knowledgeable regarding the building or campus
EAST ingress-egress path would include identification by Side, Sector, Sub-Sector, Division or Floor of EAST unit and EAST unit data including temperature, pressure and victim location

### G. Alternative Embodiment

### Disaster, Pandemic or Terrorist Attack Scenario

In an alternative embodiment, at least six months before the disaster event, the 1^{st} Responder visited the building to complete an evaluation of readiness for occupancy, i.e., site reconnaissance process 940 in FIG. 9. Each building is accessed or reconnaissance is done to ascertain the characteristics of the building. Information would be charted on paper forms for later translation to a database. This is in keeping with OSHA requirements since September 11. Building or Site Management must be able to ascertain the state of the facility and identify the location of victims, and establish the locations and characteristics of a facility for use by 1^{st} Responder in preparation for a disaster, terrorist attack or pandemic. If the paper is unavailable, compliance is impossible. The invention eliminates this risk.

1. Victim Triage

Returning to FIG. 3, in an alternative embodiment, victims/patients are identified at step 354, and patients are triaged into four categories that may be represented by colors and/or numerals. For example, Green/III could be used to identify ambulatory patients, Yellow/II not a priority transport, this specific patient (yellow) is held in a treatment sector prior to being transported. These patients can experience a change in status rapidly and require re-evaluation and status change to a Red/I status over a short period of time. A Red/I patient requires transport as soon as possible (ASAP) at step 372. If transport cannot be accomplished the patient can further deteriorate to a Black/0 status where they will be placed in a temporary morgue and not transported. This is just one example where status change can be rapid and needs to be documented. Tracking these patients becomes difficult and is usually done during the post event critique phase. Currently there is no interactive system that is dynamic enough to capture this data. The invention as presented BITS Control Flow, at step 372 provides LIC enabled connectivity to PHIN to support this process.

2. Patient Routing

In an alternative embodiment routing attempts using smart cards with swipes at ER have failed because there was no positive ID of patient. In an emergency, the 1st priority is to get the patient out. EMT is not the best way to activate the smart card information. The receiving hospital is better equipped to do this. However, when LIC is used with biometrics index it then becomes possible, given a PHIN or other connection exists at step 356, to put a bracelet on the victim at the scene that identifies the severity of the patient condition and who they are. In an alternative embodiment a bracelet could have a rip-off tab for the EMT staging officer to keep for the initial tracking that could include PHIN or other biometrics index. Tracking is a very big problem especially when EMTs are called in who are not familiar with the hospital locations. The transfer process, at step 372, usually has the EMT following a street sign (e.g. H) to get to the nearest hospital. They are in the mind of scooping and delivering quickly so that they can return to the scene. By connecting the tracking to the smart card, problems with victim tracking may occur. In an alternative embodiment, biometrics indexing would be used to identify victims at the triage points and link them via LIC software application to trauma units applications to ensure the trauma unit is capable of accepting patients; this method provides EMS a simple asset tracking system.

What is claimed is:

1. An apparatus for polling, inputting, sensing, obtaining, storing, analyzing, transmitting, and reporting data, that is composed of:
an electronic execution means providing control over said apparatus via instructions from at least one algorithm, stored in at least one file, comprised of at least one of computer programming code, macros, functions, and formulas;
a communication means;
a user input means for entering commands providing further control over said apparatus, and for entering said data and algorithms into said apparatus;
a memory means for maintaining said data in electronic and/or magnetic form;
a data compilation means for acquiring and storing said data;
a storage means for storing at least one of said data and algorithms;
a presentation means for providing an indication of said operation of said apparatus and for displaying said reports; and
an output means for outputting said reports;
which are used for:
identification of victim locations,
performing situation assessment, and
developing least risk ingress and egress paths to victims;
whereby the functionality of the invention is integrated into a single coordinated system, comprised of a plurality of components, that streamlines building intelligence and emergency personnel decision support.

2. The apparatus of claim 1 wherein:
biometrics may be used to identify one or more victims; and
connectivity with health information technologies may be established in order to retrieve and/or send health data about one or more victims.

3. A method utilizing processes for inputting, sensing, obtaining, storing, analyzing, transmitting, and reporting building intelligence data, as well as for evaluating said data and triggering a plurality of processes utilizing at least one algorithm comprised of at least one of computer programming code, macros, functions, and formulas for:
manually inputting data;
obtaining data from one or a plurality of data stores, other electronic means, or both, including, but not limited to, databases, flat files, spreadsheets, and electronic sensors;
storing said data in RAM memory, ROM-based data stores, or both;
processing said data to establish temperature, pressure, and victim coordinates;
processing said data to determine the least risk path required to remove victims safely from an emergency location;
providing instructions indicating where actions should be executed based on assessment of where said problems exist;
providing alerts and/or warnings when said when emergency personnel are at risk;
providing an electronic means to adjust decisions as required to ensure life and property is secured;
processing said data to determine the best possible outcome for the victim and the emergency personnel;
providing alerts and/or warnings when emergency personnel are in trouble;
providing alerts and/or warnings when problems occur that interfere with the proper execution of emergency personnel actions;
inputting data about the building were future problems may occur;
adjusting intelligence through a manual user interface means, an automated electronic means, or both;
collecting, storing, and analyzing data related to the results (outcomes) of emergency personnel actions; and
generating reports indicating the status of a particular building;
whereas said processes provide an efficient and unified computerized means for establishing, tracking, managing, analyzing, and reporting on the actions of emergency personnel.

4. The method of claim 3 wherein there is at least one means for tracking moving objects.

5. The method of claim 3 wherein there is at least one means for detecting at least one occurrence from the group of occurrences including human presence, man-down, site occupancy, and site intrusion.

6. The method of claim 3 wherein data can be stored in and accessed from a plurality of data stores.

7. The method of claim 3 wherein data may be input via manual data entry means and/or automated sensor means.

8. The method of claim 3 wherein one or more information technologies may be utilized in conjunction with at least one room control system and/or at least one fire and security system.

9. The method of claim 3 wherein one or more signal processing and detection devices are triggered upon the occurrence of at least one predefined condition.

10. The method of claim 3 wherein one or more workflow processes are implemented from the group of workflows including installation, certification, reconnaissance, administration, tracking and transport;
whereas consistent operational readiness and/or continuous quality improvement are promoted.
